(19) United States
(12) Patent Application Publication
(10) Pub. No.: US 2023/0166626 A1
(43) Pub. Date: Jun. 1, 2023

(54) CHARGING SYSTEM, CHARGING SCHEDULE GENERATION PROGRAM FOR CHARGING SYSTEM, AND CHARGING SCHEDULE GENERATION METHOD FOR CHARGING SYSTEM

(71) Applicant: TOYOTA JIDOSHA KABUSHIKI KAISHA, Toyota-shi Aichi-ken (JP)

(72) Inventors: Masaaki SATO, Susono-shi Shizuoka-ken (JP); Satoshi KONDO, Numazu-shi Shizuoka-ken (JP)

(73) Assignee: TOYOTA JIDOSHA KABUSHIKI KAISHA, Toyota-shi Aichi-ken (JP)

(21) Appl. No.: 17/987,931

(22) Filed: Nov. 16, 2022

(30) Foreign Application Priority Data
Nov. 29, 2021 (JP) 2021-193274

(51) Int. Cl. B60L 53/66; B60L 53/65; B60L 53/18; B60L 53/31; B60L 53/35

(52) U.S. Cl. CPC B60L 53/66; B60L 53/18; B60L 53/31; B60L 53/35; B60L 53/65

(57) ABSTRACT

A charging system according to the present disclosure includes: a storage unit configured to store vehicle information including at least a type of a vehicle and information about a charge port of the vehicle; a charging schedule management unit configured to generate, based on the vehicle information of vehicles being charged and vehicles-to-be-charged, a charging schedule including respective parking sections and respective vehicle postures for parking in the respective parking sections according to which a moving time required for the arm mechanism to move in performing a charging operation of a plurality of vehicles is reduced to the minimum; and a vehicle position control unit configured to indicate the plurality of vehicles of the respective parking sections and the respective vehicle postures for parking in the respective parking sections based on the charging schedule.

### CROSS REFERENCE TO RELATED APPLICATIONS

This application is based upon and claims the benefit of priority from Japanese patent application No. 2021-193274, filed on Nov. 29, 2021, the disclosure of which is incorporated herein in its entirety by reference.

### BACKGROUND

The present disclosure relates to a charging system, a charging schedule generation program for a charging system, and a charging schedule generation method for a charging system such as a charging system including an arm mechanism for automatically inserting and removing a charging plug from a charge port (i.e. socket) of a vehicle, a charging schedule generation method for the charging system, and a charging schedule generation method for the charging system.

In recent years, battery electric vehicles (BEV) including plug-in hybrid electric vehicles (HEV) have become widespread. Further, self-driving technique for vehicles have been improving. Under such circumstances, a system of valet parking has been proposed in which a vehicle, which is parked in a parking space at a location different from the location where a person who is a to-be-occupant of the vehicle gets into the vehicle, travels autonomously without any human driver on board between the parking space and the location where the to-be-occupant of the vehicle gets into the vehicle. In this case, the battery electric vehicle needs to be charged at the parking space, and a method of charging the battery electric vehicle at the parking space has been proposed. An example of the aforementioned technique is disclosed in Japanese Unexamined Patent Application Publication No. 2020-102220.

An automated valet parking system described in Japanese Unexamined Patent Application Publication No. 2020-102220 includes steps of: activating an automated valet parking procedure; determining whether charging of an electric vehicle is needed or not; setting a parking space for wireless charging service as a first target position when charging of the electric vehicle is needed; transmitting, by an infrastructure, the first target position and a guide route to the electric vehicle; setting an empty parking space as a second target position after the charging of the electric vehicle is completed; and transmitting the second target position and the guide route to the electric vehicle.

### SUMMARY

When an arm mechanism inserts a charging plug into a charge port of a vehicle, time required for the arm mechanism to move affects the charging time. In particular, at a charging station where charging is performed for a large number of vehicles, the overall charging efficiency of the system is greatly impacted by shortening the time required for the arm mechanism to move. However, there is not mention of the time loss due to the arm mechanism in the technique described in Japanese Unexamined Patent Application Publication No. 2020-102220 and it is not possible to solve the charging insufficiency due to the time loss caused by moving of the arm mechanism.

The present disclosure has been made to solve the problem mentioned above and an object of the present disclosure is to improve the charging efficiency of a charging system configured to insert and remove a charging plug from a charge port (i.e. socket) of a vehicle using an arm mechanism.

A first exemplary aspect is a charging system including:
an arm mechanism configured to grasp a charging plug connected to a charging apparatus through a charging cable and automatically perform plugging / unplugging of the charging plug to and from a charge port of a vehicle parked in a charging area;
a storage unit configured to store vehicle information including at least a type of the vehicle and information about a charge port of the vehicle;
a charging schedule management unit configured to generate, based on the vehicle information of vehicles being charged and vehicles-to-be-charged, a charging schedule including respective parking sections and respective vehicle postures for parking in the respective parking sections according to which a moving time required for the arm mechanism to move in performing a charging operation of a plurality of vehicles is reduced to the minimum; and
a vehicle position control unit configured to indicate the plurality of vehicles of the respective parking sections and the respective vehicle postures for parking in the respective parking sections based on the charging schedule.

Another exemplary aspect is a program for a charging system comprising an arm mechanism configured to grasp a charging plug connected to a charging apparatus through a charging cable and automatically perform plugging / unplugging of the charging plug to and from a charge port of a vehicle parked in a charging area, the program executed by a control unit of the charging system configured to control the vehicle and adapted to cause the charging system to perform processes of:
reading-out vehicle information including at least a type of the vehicle and information about a charge port of the vehicle from a storage unit accessible by the charging system;
generating, based on the vehicle information of vehicles being charged and vehicles-to-be-charged, a charging schedule including respective parking sections and respective vehicle postures for parking in the respective parking sections according to which a moving time required for the arm mechanism to move in performing a charging operation of a plurality of vehicles is reduced to the minimum; and
indicating the plurality of vehicles of the respective parking sections and the respective vehicle postures for parking in the respective parking sections based on the charging schedule.

Another exemplary aspect is a charging system generation method for a charging system that includes an arm mechanism configured to grasp a charging plug connected to a charging apparatus through a charging cable and automatically perform plugging / unplugging of the charging plug to and from a charge port of a vehicle parked in a charging area, the charging system generation method including:
reading-out vehicle information including at least a type of the vehicle and information about a charge port of the vehicle from a storage unit accessible by the charging system;
generating, based on the vehicle information of vehicles being charged and vehicles-to-be-charged, a charging schedule including respective parking sections and respective vehicle postures for parking in the respective parking sections according to which a moving time required for the arm mechanism to move in performing a charging operation of a plurality of vehicles is reduced to the minimum; and
indicating the plurality of vehicles of the respective parking sections and the respective vehicle postures for parking in the respective parking sections based on the charging schedule.

A charging system, a charging schedule generation program for a charging system, and a charging schedule generation method for a charging system according to the present disclosure are each adapted to park a vehicle so that a first spacing required for handling the arm mechanism on the charge port side of the vehicle is wider than a second spacing on a side opposite the charge port side of the vehicle.

According to the present disclosure, it is possible to increase the number of vehicles that can be parked in a parking area having a limited size while securing a space for handling the arm mechanism.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram of a charging system according to a first embodiment;

FIG. 2 is a schematic diagram of parking areas in the charging system according to the first embodiment;

FIG. 3 is a flowchart for explaining operations of the charging system according to the first embodiment;

FIG. 4 is a flowchart for explaining a charging schedule generation process of the charging system according to the first embodiment; and

FIG. 5 is a flowchart for explaining a charging schedule generation process of a charging system according to a second embodiment.

### DESCRIPTION OF EMBODIMENTS

The same or corresponding elements are denoted by the same reference numerals (or symbols) throughout the drawings, and redundant descriptions thereof are omitted as required for clarifying the explanation. Further, each of the elements shown in the drawings as function blocks indicating various processes can be configured of a CPU (Central Processing Unit), a memory, and other circuits in terms of a hardware configuration, and can be implemented by programs loaded in a memory or the like in terms of a software configuration. Therefore, a skilled person in the art can understand that these function blocks can be realized in various forms such as a hardware configuration alone, a software configuration alone, or a combination thereof, and are not limited to any one of them. Note that the same or corresponding elements are denoted by the same reference numerals (or symbols) throughout the drawings, and redundant descriptions thereof are omitted as required.

Further, the above-described program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

### First Embodiment

In a charging system described below, a charging plug provided at the tip of a charging cable is inserted into a charge port of a vehicle such as a battery electric vehicle using an arm mechanism, and the battery electric vehicle is charged accordingly. Here, in the charging system, a vehicle to be charged includes not only a vehicle which a person who is a to-be-occupant of the vehicle can get into but also includes a vehicle that can move autonomously without any human driver on board. Further, in a parking area which is a region to be managed by the charging system, vehicles travel by following instructions from the charging system.

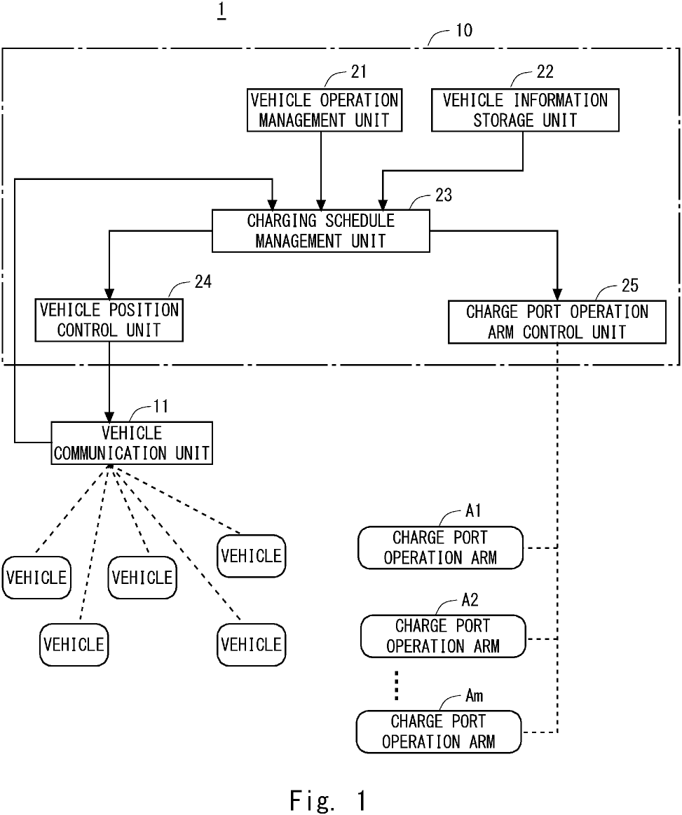

FIG. 1 shows a block diagram of a charging system 1 according to a first embodiment. Note that parking areas that are managed by the charging system are omitted in FIG. 1. As shown in FIG. 1, the charging system 1 according to the first embodiment includes a control unit (e.g. a management apparatus 10) and a vehicle communication unit 11. Further, in FIG. 1, vehicles-to-be-monitored by the charging system 1 and an arm mechanism (e.g. charge port operation arms A1 to Am (m is an integer indicating the number of the charge port operation arms)) to be controlled by the charging system 1 are shown. It is to be noted that the number of the vehicles to be managed by the charging system 1 may be one, and there is no need to manage a plurality of vehicles.

First, the charging system 1 includes an arm mechanism (e.g. the charge port operation arms A1 to Am) for grasping a charging plug connected to a charging apparatus through a charging cable and automatically performing plugging / unplugging of the charging plug to and from a charge port of a vehicle parked in a charging area. Then, the charging system 1 connects the charging cable extending from the charging apparatus to a vehicle-to-be-charged among a plurality of vehicles that are waiting to be charged in the charging area and performs charging of the vehicle-to-be charged. Further, the charging system 1 indicates, using the control unit (e.g. the management apparatus 10), the charging position to the vehicle-to-be-charged for connecting the charging cable. At this time the management apparatus 10 generates, based on the aforementioned vehicle information of the vehicles being charged and the vehicles-to-be-charged, a charging schedule including respective parking sections and respective vehicle postures for parking in the parking sections of a plurality of vehicles according to which the moving time required for the arm mechanism to move in performing a charging operation of a plurality of vehicles is reduced to the minimum is generated. Further, in the first embodiment, by giving an instruction to travel to the vehicle-to-be-charged in accordance with the aforementioned charging schedule, the moving time required for the charge port operation arm mechanism to move can be reduced to the minimum. Further, the charging system 1 have the management apparatus 10 perform communication with a vehicle using the vehicle communication unit 11 and provides a traveling route to the vehicle and instructs the vehicle to move along the traveling route. The vehicle communication unit 11 controls communication performed between the management apparatus 10 and the vehicle based on the prescribed communication protocols.

The process blocks shown in the management apparatus 10, which is shown in FIG. 1, can be implemented by an exclusive hardware or by executing programs in an operation unit of an operation device such as a computer. Further, as regards a storage unit among the process blocks shown in the management apparatus 10, it can be realized by a storage apparatus that is accessible by a computer.

The management apparatus 10 includes a vehicle operation management unit 21, a vehicle information storage unit 22, a charging schedule management unit 23, a vehicle position control unit 24, and a charge port operation arm control unit 25. The vehicle operation management unit 21 manages exit/entry of a vehicle from / into a parking space in accordance with a request from a user of the vehicle. Further, the vehicle operation management unit 21 performs communication with a vehicle using another communication channel (not shown) and determines the operation schedule of the vehicle, the traveling distance of the vehicle, and the state of charge of the vehicle. The vehicle information storage unit 22 is a database for holding specifications by vehicle types such as the position of a charge port, the standards of the charge port, the full-charge capacity of the vehicle, and the like as the vehicle information.

The charging schedule management unit 23 generates a charging schedule for efficiently performing charging of a vehicle to be managed based on the state of the vehicle, the operation schedule and the vehicle information obtained from the vehicle operation management unit 21 and the vehicle information storage unit 22. To be more specific, the charging schedule management unit 23 generates, based on the vehicle information of the vehicles being charged and the vehicles-to-be-charged, a charging schedule including respective parking sections and respective vehicle postures for parking in the parking sections of a plurality of vehicles according to which the moving time required for the arm mechanisms (charge port operation arms A1 to Am) to move in performing a charging operation of a plurality of vehicles is reduced to the minimum. Details of the aforementioned charging schedule generation process will be described later.

Based on the charging schedule generated by the charging schedule management unit 23, the vehicle position control unit 24 designates a parking position for a vehicle that has entered a parking area, changes the parking position to that for charging, and instructs the vehicle to travel. The charge port operation arm control unit 25 instructs the charge port operation arms A1 to Am to select the charging cable according to the charging schedule generated by the charging schedule management unit 23 and to perform operation of inserting the charging plug into the insertion port of the vehicle.

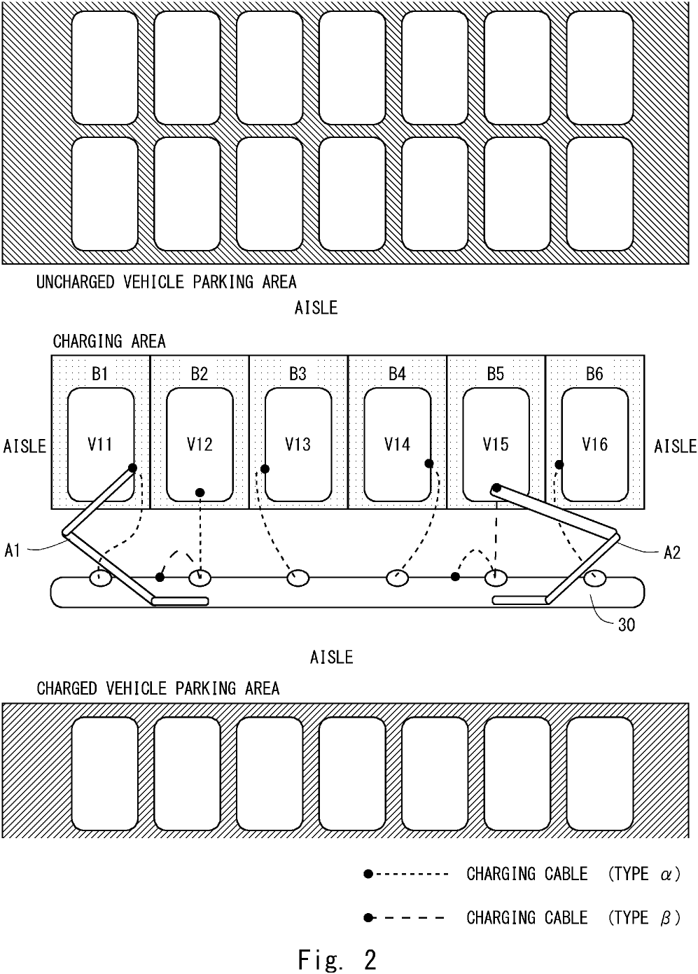

Here, a configuration of parking areas of the charging system 1 according to the first embodiment will be described. FIG. 2 shows a schematic diagram of the parking areas in the charging system according to the first embodiment. As shown in FIG. 2, a charging apparatus 30 is disposed in the parking area. A charging area corresponding to the charging apparatus 30 is provided. Further, in the example shown in FIG. 2, a plurality of (six in FIG. 2) parking sections B1 to B6 for charging are provided in the charging area. The example shown in FIG. 2 shows a state in which vehicles V11 to V16 are parked in the parking sections B1 to B6 for charging, respectively.

Further, the parking areas managed by the charging system 1 include an uncharged vehicle parking area for parking vehicles that are not yet charged and a charged vehicle parking area for parking vehicles that have been charged are placed on standby. A vehicle that has entered the parking area is parked in the uncharged vehicle parking area and a vehicle that has been charged is parked in the charged vehicle parking area where it waits to exit the parking area.

Further, in the example shown in FIG. 2, the charging apparatus 30 has charging cables that are compatible with two types of charge ports. In the example shown in FIG. 2, charging cables to each of which a charging plug compatible with the charge port type α is provided and charging cables to each of which a charging plug compatible with the charge port type β is provided are shown. Further, the charge port operation arms A1 and A2 are attached to the charging apparatus 30. In FIG. 2, two charge port operation arms that correspond to the charging area are shown, but the number of the charge port operation arm may be one.

Further, as shown in FIG. 2, in the charging system 1 according to the first embodiment, respective parking sections and respective vehicle postures for parking in the parking sections are designated for a plurality of vehicles such that the moving time required for the charge port operation arms A1 and A2 in the parking sections for charging in the charging area to move is reduced to the minimum. FIG. 2 shows examples in which adjustment is made as to the vehicle postures for parking in the respective parking sections so that the vehicles are either head-in parked or reverse-parked based on the charging schedule generated by the charging schedule management unit 23. In the example shown in FIG. 2, when the vehicles-to-be-charged are parked in the parking sections for charging B1 to B3, they are parked in such a way that respective charge ports come close to the charge port operation arm A1 and when the vehicles-to-be-charged are parked in the parking sections for charging B4 to B6, they are parked in such a way that respective charge ports come close to the charge port operation arm A2. Further, FIG. 2 shows an example in which the respective parking sections and the respective vehicle postures for parking in the parking sections are adjusted for each vehicle in such a way that the charge ports of the vehicles come close to the charging apparatus 30.

The charging system 1 makes the vehicle parked in the uncharged vehicle parking area travel to the charging area and makes the vehicle for which charging has been completed travel from the charging area to the charged vehicle parking area by using either one of the aisles disposed on the sides of the charging area as a route thereof. In this way, the charging system 1 according to the first embodiment adjusts the parking section and the vehicle posture for parking in the parking section for each of the vehicles in accordance with the positions of the respective charge ports. That is, in the charging system 1 according to the first embodiment, an instruction to travel given to a vehicle-to-be-charged is output as a parking position adjustment instruction by the vehicle position control unit 24 based on charging assistance rules and the parking position adjustment instruction is given to the vehicle-to-be-charged.

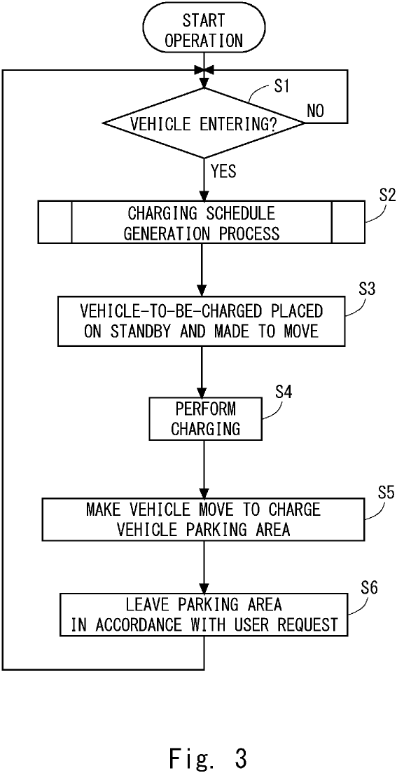

Next, how the charging system 1 according to the first embodiment operates will be described. FIG. 3 shows a flowchart for explaining operations of the charging system 1 according to the first embodiment. As shown in FIG. 3, in the charging system 1 according to the first embodiment, various processes are started in accordance with entry of a vehicle in the parking area (Step S1). In the charging system 1 according to the first embodiment, a charging schedule generation process is performed based on the vehicle information of the vehicle that has entered the parking area (Step S2). In the aforementioned charging schedule generation process, a charging schedule according to which the moving time required for the charge port operation arm to move is reduced to the minimum is generated. Details of charging schedule generation process will be described later. Then, based on the charging schedule generated in Step S2, the management apparatus 10 indicates the standby position for the vehicle-to-be-charged and the makes the vehicle-to-be-charged move (Step S3). Further, in Step S3, in accordance with the charging schedule, the vehicle-to-be-charged is made to travel from the uncharged vehicle parking area to the charging area.

Then, the charging system 1 according to the first embodiment performs charging of the vehicle-to-be-charged which has been made to travel to the charging area in Step S3 (Step S4). After the charging is completed, the charging system 1 makes the vehicle travel from the charging area to the charged vehicle parking area (Step S5), and in accordance with a request from the user, the vehicle parked in the charged vehicle parking area is made to exit the charged vehicle parking area (Step S6).

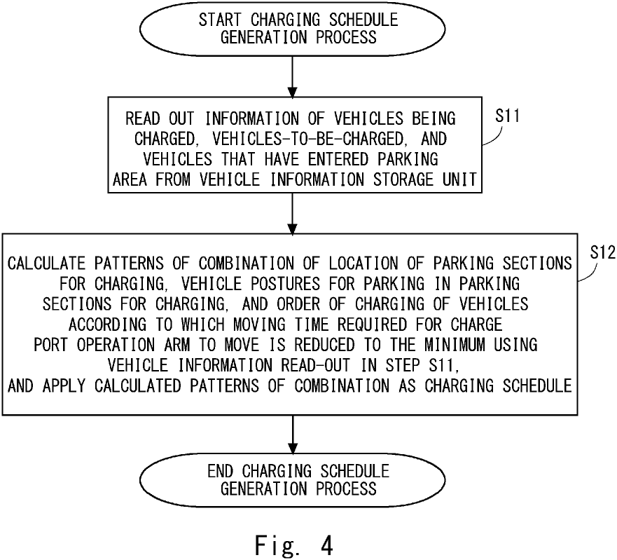

Here, details of the charging schedule generation process of Step S2 will be described in detail. FIG. 4 shows a flowchart for explaining a charging schedule generation process of the charging system according to the first embodiment. The charging schedule generation process shown in FIG. 4 is performed by the charging schedule management unit 23.

As shown in FIG. 4, the charging schedule management unit 23 according to the first embodiment reads out the vehicle information of the vehicles being charged, the vehicles-to-be-charged, and the vehicles that have entered the parking area from the vehicle information storage unit 22 (Step S11). Next, using the vehicle information read-out in Step S11, the charging schedule management unit 23 according to the first embodiment calculates patterns of combination of the location of the parking sections for charging, the vehicle postures for parking in the parking sections for charging, and the order of charging of the vehicles according to which the moving time required for the charge port operation arm to move is reduced to the minimum and applies the calculated patterns of combination as the charging schedule (Step S12).

Here, the patterns of combination of the location of the parking sections for charging, the vehicle posture for parking in the parking sections for charging, and the order of charging of the vehicles will be described in detail. An example of the charging schedule management unit 23 is an optimization device utilizing artificial intelligence. By providing the vehicle information read-out in Step S11 to the aforementioned optimization device that utilizes artificial intelligence, it is possible to generate a charging schedule according to which the moving time required for the charge port operation arm to move is reduced to the minimum in a relatively short time.

Further, in another example of the charging schedule management unit 23, an optimization process is performed in which a candidate of an optimal pattern of combination is generated by combining the locations of the parking sections for charging, the vehicle postures for parking in the parking sections for charging, and the order of charging of the vehicles in accordance with a prescribed rule, and then an estimated value of the moving time required for the charge port operation arm to move is calculated in view of the candidate of the optimal pattern of combination, and assessment of the estimated value is performed.

Further, in another example of the charging schedule management unit 23, an order determining process of adjusting the vehicle posture for parking in the parking section for charging so that the locations of the charge ports of the parked vehicles are aligned in accordance with the parking sections for charging and the order of charging determined based on the state of charge etc. of the vehicle may be performed.

As described above, in the charging system 1 according to the first embodiment, a charging schedule according to which the moving time required for the arm mechanisms to move is reduced to the minimum is generated. Then, by plugging a charging plug into a charge port in accordance with the aforementioned charging schedule, the moving time required for a charge port operation arm to move can be reduced to the minimum. By shortening the moving time required for the charge port operation arm to move, it is possible to enhance the overall charging efficiency of the charging system 1 according to the first embodiment.

### Second Embodiment

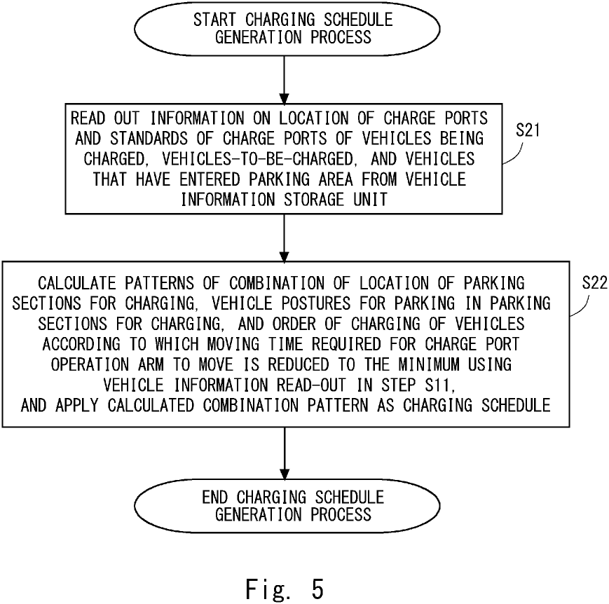

In a second embodiment, another example of a charging schedule generation process will be described. FIG. 5 shows a flowchart for explaining a charging schedule generation process of a charging system according to a second embodiment.

As shown in FIG. 5, the charging schedule generation process according to the second embodiment is the same as the charging schedule generation process of the charging system according to the first embodiment except that Steps S11 and S12 in FIG. 4 have been replaced by Steps S21 and S22, respectively. In Step S21, vehicle information, which includes the standards of the charge ports in addition to the data items of the vehicle information read out in Step S11, is read out. In Step S22, a charging schedule according to which the moving time required for the charge port operation arm to move is reduced to the minimum is generated by using the vehicle information read out in Step S21.

In the charging schedule generation process according to the second embodiment, since vehicle information including the types of charge ports is used for generating a charging schedule, it is possible to reduce the moving time required for the charge port operation arm to move, for example, to change the charging cable it is holding to another one in accordance with the type of the charge port. That is, by using the charging schedule generation process according to the second embodiment, it is possible to shorten the moving time required for the charge port operation arm to move compared to that in the charging system 1 according to the first embodiment.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A charging system comprising:
an arm mechanism configured to grasp a charging plug connected to a charging apparatus through a charging cable and automatically perform plugging / unplugging of the charging plug to and from a charge port of a vehicle parked in a charging area;
a storage unit configured to store vehicle information including at least a type of the vehicle and information about a charge port of the vehicle;
a charging schedule management unit configured to generate, based on the vehicle information about vehicles being charged and vehicles-to-be-charged, a charging schedule including respective parking sections and respective vehicle postures for parking in the respective parking sections according to which a moving time required for the arm mechanism to move in performing a charging operation of a plurality of vehicles is reduced to a minimum; and
a vehicle position control unit configured to indicate the plurality of vehicles of the respective parking sections and the respective vehicle postures for parking in the respective parking sections based on the charging schedule.

2. The charging system according to claim 1, wherein the charging schedule management unit is configured to
estimate the moving time required for the arm mechanism to move for each of patterns of combination of locations of the respective charge ports, the respective parking sections, and the respective vehicle postures for parking in the respective parking sections of the plurality of vehicles including the vehicles being charged and the vehicles-to-be-charged and
generate the charging schedule based on the patterns of combination according to which a smallest estimated value is obtained.

3. The charging system according to claim 2, wherein the charging schedule management unit is configured to calculate the estimated value by including information on standards of the charge ports in the patterns of combination.

4. The charging system according to claim 1, wherein the charging schedule management unit performs an optimization process using artificial intelligence to generate the charging schedule according to which the moving time required for the arm mechanism to move in performing the charging operation is reduced to the minimum.

5. A non-transitory computer readable medium storing a program for a charging system comprising an arm mechanism configured to grasp a charging plug connected to a charging apparatus through a charging cable and automatically perform plugging / unplugging of the charging plug to and from a charge port of a vehicle parked in a charging area, the program executed by a control unit of the charging system configured to control the vehicle and adapted to cause the charging system to perform processes of:
reading-out vehicle information including at least a type of the vehicle and information about a charge port of the vehicle from a storage unit accessible by the charging system;
generating, based on the vehicle information of vehicles being charged and vehicles-to-be-charged, a charging schedule including respective parking sections and respective vehicle postures for parking in the respective parking sections according to which a moving time required for the arm mechanism to move in performing a charging operation of a plurality of vehicles is reduced to a minimum; and
indicating the plurality of vehicles of the respective parking sections and the respective vehicle postures for parking in the respective parking sections based on the charging schedule.

6. A charging system generation method for a charging system that comprises an arm mechanism configured to grasp a charging plug connected to a charging apparatus through a charging cable and automatically perform plugging / unplugging of the charging plug to and from a charge port of a vehicle parked in a charging area, the charging system generation method comprising:
reading-out vehicle information including at least a type of the vehicle and information about a charge port of the vehicle from a storage unit accessible by the charging system;
generating, based on the vehicle information of vehicles being charged and vehicles-to-be-charged, a charging schedule including respective parking sections and respective vehicle postures for parking in the respective parking sections according to which a moving time required for the arm mechanism to move in performing a charging operation of a plurality of vehicles is reduced to a minimum; and
indicating the plurality of vehicles of the respective parking sections and the respective vehicle postures for parking in the respective parking sections based on the charging schedule.
